(19) United States
(12) Patent Application Publication
(10) Pub. No.: US 2023/0092632 A1
(43) Pub. Date: Mar. 23, 2023

(54) ANTENNA APPARATUS AND RADIO COMMUNICATIONS DEVICE

(71) Applicant: HUAWEI TECHNOLOGIES CO., LTD., Shenzhen, Guangdong (CN)

(72) Inventors: Feng Ding, Suzhou (CN); Chunying Nai, Suzhou (CN); Bo Yuan, Suzhou (CN)

(73) Assignee: HUAWEI TECHNOLOGIES CO., LTD., Shenzhen, Guangdong (CN)

(21) Appl. No.: 18/052,574

(22) Filed: Nov. 4, 2022

Related U.S. Application Data
(63) Continuation of application No. PCT/CN2021/094709, filed on May 19, 2021.

(30) Foreign Application Priority Data
May 22, 2020 (CN) 202010440048.X

(51) Int. Cl. H01Q 21/24; H01Q 1/24; H01Q 1/42; H01Q 19/10

(52) U.S. Cl. CPC H01Q 21/24; H01Q 1/24; H01Q 1/42; H01Q 19/10

(57) ABSTRACT

An antenna apparatus and a radio communications device are disclosed. The antenna apparatus includes a circuit board and a plurality of radiators. The plurality of radiators are all located on the circuit board. The plurality of radiators form at least one radiator array. Each radiator array includes a first column of radiators and a second column of radiators. In each radiator array, a polarization direction of the first column of radiators is perpendicular to a polarization direction of the second column of radiators, and radiators in the first column of radiators and radiators in the second column of radiators do not overlap. An end of each radiator in the first column of radiators points to a target location range of an adjacent radiator in the second column of radiators.

### CROSS-REFERENCE TO RELATED APPLICATIONS

This application is a continuation of International Application No. PCT/CN2021/094709, filed on May 19, 2021, which claims priority to Chinese Patent Application No. 202010440048.X, filed on May 22, 2020. The disclosures of the aforementioned applications are hereby incorporated by reference in their entireties.

### TECHNICAL FIELD

This application relates to the wireless communications field, and in particular, to an antenna apparatus and a radio communications device.

### BACKGROUND

An antenna apparatus is a device for radiating and receiving an electromagnetic wave, and is configured to implement conversion between a current and an electromagnetic wave. It mainly includes a radiator configured to radiate and receive an electromagnetic wave and a feeding component configured to feed the radiator.

For a dual-polarized antenna, two radiators whose polarization directions are perpendicular to each other may be disposed on a circuit board in an overlapping and crossing manner. However, in such a disposing manner, a large quantity of welding technologies or surface-mounting technologies are used in manufacturing. This results in complex processing and manufacturing processes and relatively low processing efficiency of an antenna apparatus.

### SUMMARY

This application provides an antenna apparatus and a radio communications device, which can simplify antenna processing and manufacturing processes.

According to one aspect, an antenna apparatus is provided. The antenna apparatus includes a circuit board and a plurality of radiators, where the plurality of radiators are all located on the circuit board, the plurality of radiators form at least one radiator array, and each radiator array includes a first column of radiators and a second column of radiators; and

in each radiator array, a polarization direction of the first column of radiators is perpendicular to a polarization direction of the second column of radiators, and radiators in the first column of radiators and radiators in the second column of radiators do not overlap; and an end of a first radiator in the first column of radiators points to a target location range of an adjacent second radiator in the second column of radiators, so that an isolation degree between the adjacent first radiator and second radiator meets an isolation degree requirement, and a distance between the adjacent first radiator and second radiator is shortest.

In an example, the radiators in the first column of radiators and the radiators in the second column of radiators do not overlap. The radiators in the first column of radiators and the radiators in the second column of radiators are staggered from each other at physical spatial locations, so as to increase an isolation degree, and reduce and even avoid mutual interference between the radiators in the first column of radiators and the radiators in the second column of radiators.

In an example, on the basis that an isolation degree between two adjacent radiators (one is located in the first column of radiators and the other is located in the second column of radiators) meets a minimum requirement of the isolation degree requirement, the first column of radiators and the second column of radiators are made as close to each other as possible, so as to reduce a space occupied by the antenna apparatus and make the antenna apparatus compact. For example, the end of the first radiator in the first column of radiators points to the target location range of the adjacent second radiator in the second column of radiators. The first radiator is any radiator in the first column of radiators, and the second radiator is a radiator in the second column of radiators.

As shown in FIG. 3, the adjacent first radiator and second radiator may be a radiator located in the first column of radiators and a radiator located in the second column of radiators, or may be a radiator located in the first column of radiators and a radiator located in the second column of radiators.

In an example, when an end of a radiator in the first column of radiators points to a target location range of an adjacent radiator in the second column of radiators, and an isolation degree between the radiators meets the minimum requirement of the isolation degree requirement, a spacing between the first column of radiators and the second column of radiators is also minimal.

Meeting the isolation degree requirement may be meeting the minimum requirement of the isolation degree requirement. Meeting the minimum requirement of the isolation degree requirement may be being exactly equal to a minimum isolation degree, or being slightly greater than the minimum isolation degree. For example, if the minimum requirement of the isolation degree requirement is 18 dB (decibel, decibel), the isolation degree between the radiators may be exactly 18 dB, or may be slightly greater than 18 dB.

A target location range of a radiator (any radiator) may be a location range formed by a middle location on the radiator and an area adjacent to the middle location on the radiator. For example, a target location range of a radiator with a linear-shape appearance may be a location range that is formed by using a straight line at which the radiator is located as a coordinate axis and a middle location on the radiator as a center, and in which the radiator can move leftward for a specified distance and rightward for a specified distance. In this way, an end of each radiator in the first column of radiators may point to a middle location on an adjacent radiator in the second column of radiators, or may point to a specific location close to a middle location on an adjacent radiator in the second column of radiators.

This application sets no absolute limitation on a specific location pointed to by the end of each radiator in the first column of radiators, provided that the minimum requirement of the isolation degree requirement can be met, and the antenna apparatus has highest compactness.

An end of a radiator may point to a target location range of another radiator, or may be pointed to by an end of another radiator.

In an example, as shown in FIG. 1, when the first column of radiators includes three radiators: a radiator 2a, a radiator 2b, and a radiator 2c, and the second column of radiators includes three radiators: a radiator 2d, a radiator 2e, and a radiator 2f, each radiator in the first column of radiators is adjacent to one or two radiators in the second column of radiators, and each radiator in the second column of radiators is adjacent to one or two radiators in the first column of radiators. For example, as shown in FIG. 3, for the radiator 2a in the first column of radiators that is adjacent to the radiator 2f and the radiator 2e in the second column of radiators, an end of the radiator 2a points to a target location range of the radiator 2f in the second column of radiators, and a target location range of the radiator 2a is pointed to by an end of the radiator 2e in the second column of radiators. Similarly, for the radiator 2e in the second column of radiators that is adjacent to the radiator 2a and the radiator 2b in the first column of radiators, the end of the radiator 2e points to the target location range of the adjacent radiator 2a in the first column of radiators, and a target location range of the radiator 2e is pointed to by an end of the other adjacent radiator 2b in the first column of radiators.

Based on the foregoing description, all the radiators of the array antenna apparatus are located on one circuit board, that is, share the circuit board. The end of each radiator in the first column of radiators in the radiator array points to a target location range of an adjacent radiator in the second column of radiators. In this way, the first column of radiators and the second column of radiators are as close to each other as possible while a requirement of the isolation degree requirement is met, thereby implementing compactness of the antenna apparatus. Compared with dual polarization implemented by overlapping radiators in a related technology, in the dual-polarized antenna apparatus with the foregoing arrangement, all the radiators are printed on the circuit board. Processing and manufacturing processes are simple, production efficiency is high, manufacturing costs are low, and large-scale production of the antenna apparatus can be implemented.

In a possible implementation, the target location range of the second radiator is a location range formed by a middle location on the second radiator and an area location adjacent to the middle location on the second radiator.

In a possible implementation, in each radiator array, physical locations of the first column of radiators and the second column of radiators are staggered from each other.

In an example, ends of the radiators in the first column of radiators all extend into an array of the second column of radiators, and ends of the radiators in the second column of radiators all extend into an array of the first column of radiators. For example, still referring to FIG. 3, the ends of the radiator 2a, the radiator 2b, and the radiator 2c located in the first column of radiators all extend into the array of the second column of radiators, and the ends of the radiator 2d, the radiator 2e, and the radiator 2f in the second column of radiators all extend into the array of the first column of radiators.

In this way, the two columns of radiators in each radiator array in the antenna apparatus are staggered from each other. This can improve space utilization of the antenna apparatus and facilitate compactness of the antenna apparatus.

In a possible implementation, the antenna apparatus further includes a feeding component, the feeding component is located on the circuit board, and the feeding component is electrically connected to each of the plurality of radiators.

In an example, compared with making the feeding component perpendicular to the circuit board, deploying the feeding component on the circuit board can simplify connections between the feeding component and the radiators, and save a large quantity of welding or mounting processes.

The feeding component and the radiators share one circuit board, that is, the feeding component and the radiators are deployed on a same circuit board in a printing manner. This can greatly simplify processing and manufacturing of the antenna apparatus, improve production and processing efficiency, reduce a cost, and facilitate large-scale production of the antenna apparatus.

In a possible implementation, the antenna apparatus further includes a reflection panel, the circuit board is mounted on the reflection panel, and a distance between the reflection panel and the circuit board falls within a specified value range.

In an example, the reflection panel can enable the antenna apparatus to be a directional antenna, to transmit an electromagnetic wave in a specified direction and receive an electromagnetic wave sent in a specified direction, thereby implementing directionalization of the antenna apparatus.

In a possible implementation,

a location that is on the reflection panel and that corresponds to a first boundary of the first column of radiators is bent toward a direction of the circuit board to form a first inclined surface, the first boundary of the first column of radiators is a column boundary far from the second column of radiators, and the first inclined surface is configured to reflect an electromagnetic wave radiated by the second column of radiators in the radiator array in which the first column of radiators is located; and

a location that is on the reflection panel and that corresponds to a first boundary of the second column of radiators is bent toward the direction of the circuit board to form a second inclined surface, the first boundary of the second column of radiators is a column boundary far from the first column of radiators, and the second inclined surface is configured to reflect an electromagnetic wave radiated by the first column of radiators in the radiator array in which the second column of radiator is located.

In an example, the first inclined surface reflects an electromagnetic wave emitted by a radiator in the second column of radiators, and the second inclined surface reflects an electromagnetic wave emitted by a radiator in the first column of radiators. This can optimize a directivity pattern of the antenna apparatus and improve symmetry of the directivity pattern.

In a possible implementation, a location that is on the reflection panel and that corresponds to an intersection between the first column of radiators and the second column of radiators in the radiator array protrudes toward the direction of the circuit board to form a third inclined surface and a fourth inclined surface, the third inclined surface is configured to reflect an electromagnetic wave of the second column of radiators, and the fourth inclined surface is configured to reflect an electromagnetic wave of the first column of radiators.

The antenna apparatus optimizes the directivity pattern of the antenna apparatus and improves symmetry of the directivity pattern by using reflection functions of the first inclined surface, the second inclined surface, the third inclined surface, and the fourth inclined surface of the reflection panel on electromagnetic waves of the radiators, so that a coverage area of the antenna apparatus is uniform and communication quality is improved.

In a possible implementation, a polarization direction of each radiator in the first column of radiators is +45 degrees, and a polarization direction of each radiator in the second column of radiators is −45 degrees.

In an example, the polarization direction of the first column of radiators may be +45 degrees, and the polarization direction of the second column of radiators may be −45 degrees. Alternatively, the polarization direction of the first column of radiators may be −45 degrees, and the polarization direction of the second column of radiators may be +45 degrees. This further enables the antenna apparatus to have a dual polarization feature.

In a possible implementation, each of the radiators includes a high-frequency radiating element and a low-frequency radiating element, and the high-frequency radiating element and the low-frequency radiating element are located on the circuit board in parallel.

An operating band of the high-frequency radiating element may be 5 GHz, and an operating band of the low-frequency radiating element may be 2.4 GHz. The antenna apparatus has two operating bands: 2.4 GHz and 5 GHz, so that the antenna apparatus is a dual-band dual-polarized antenna, thereby extending functions of the antenna apparatus.

In a possible implementation, each of the plurality of radiators includes two radiation elements that are symmetrical to each other, a first radiation element in the two radiation elements is located on a first surface of the circuit board, a second radiation element in the two radiation elements is located on a second surface of the circuit board, and the first surface is opposite to the second surface.

In a possible implementation, the antenna apparatus further includes a protective cover, and both the circuit board and the plurality of radiators are located inside the protective cover.

In an example, the circuit board and the plurality of radiators located on the circuit board each are covered inside the protective cover to protect the circuit board and the radiators.

According to another aspect, a radio communications device is further provided. The radio communications device includes a radio device and the foregoing antenna apparatus. The feeding component of the antenna apparatus is electrically connected to the radio device.

The antenna apparatus provided in this application includes the circuit board and the plurality of radiators located on the circuit board. The plurality of radiators may form at least one radiator array, and each radiator array may include the first column of radiators and the second column of radiators. The end of each radiator in the first column of radiators points to a target location range of an adjacent radiator in the second column of radiators, so as to meet a requirement of the isolation degree requirement and compactness of the antenna apparatus. In the dual-polarized antenna apparatus provided with the foregoing arrangement, the first column of radiators and the second column of radiators whose polarization directions are perpendicular to each other are printed on the same circuit board to simplify the processing and manufacturing processes and reduce the manufacturing costs. In addition, the first column of radiators and the second column of radiators whose polarization directions are perpendicular to each other are staggered from each other, so that the antenna apparatus can be more compact while the isolation degree requirement is met.

### BRIEF DESCRIPTION OF DRAWINGS

FIG. 1 is a schematic diagram of a structure of an antenna apparatus according to this application;

FIG. 2 is a schematic diagram of a structure of an antenna apparatus according to this application;

FIG. 3 is a schematic diagram of a structure of an antenna apparatus according to this application;

FIG. 4 is a schematic diagram of a structure of an antenna apparatus according to this application;

FIG. 5 is a schematic diagram of a structure of an antenna apparatus according to this application;

FIG. 6 is a schematic diagram of a structure of an antenna apparatus according to this application; and

FIG. 7 is a schematic diagram of a structure of an antenna apparatus according to this application.

Legend description:

| | |
|---|---|
| 1. circuit board; | 2. radiator; |
| 3. feeding component; | 4. reflection panel; |
| 20. radiator array; | 21. high-frequency radiating |
| 22. low-frequency radiating | element; |
| element; | 42. second inclined surface; |
| 41. first inclined surface; | 44. fourth inclined surface; |
| 43. third inclined surface; | 202. second column of radiators; and |
| 201. first column of radiators; | 221. radiation element of a low- |
| 211. radiation element of a high- | frequency radiating element. |
| frequency radiating element; | |

### DESCRIPTION OF EMBODIMENTS

This application relates to an antenna apparatus. The antenna apparatus may be an antenna apparatus of a wireless access point, an antenna apparatus of a base station, an antenna apparatus of a router, or the like. The antenna apparatus may be configured to radiate an electromagnetic wave, receive an electromagnetic wave, or radiate and receive an electromagnetic wave.

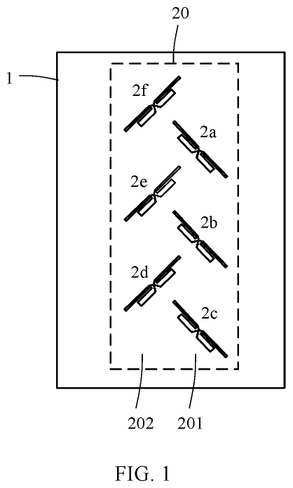

As shown in FIG. 1, the antenna apparatus may include a circuit board 1 and a plurality of radiators 2 (radiators 2a to 2f shown in FIG. 1). The plurality of radiators 2 are all located on the circuit board 1. The plurality of radiators 2 form at least one radiator array 20. Each radiator array 20 includes a first column 201 of radiators and a second column 202 of radiators. In each radiator array 20, a polarization direction of the first column 201 of radiators is perpendicular to a polarization direction of the second column 202 of radiators, and the radiators 2a to 2c in the first column 201 of radiators and the radiators 2d to 2f in the second column 202 of radiators do not overlap. An end of a first radiator (for example, any one of the radiator 2a, the radiator 2b, and the radiator 2c in FIG. 1) in the first column 201 of radiators points to a target location range of an adjacent second radiator in the second column 202 of radiators, so that an isolation degree between the adjacent first radiator and second radiator meets an isolation degree requirement, and a distance between the adjacent first radiator and second radiator is shortest. That a distance between the two radiators is shortest may also be considered as follows: a distance between the first column 201 of radiators and the second column 202 of radiators is shortest.

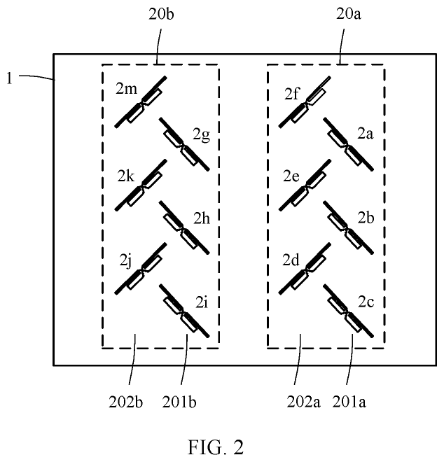

In an example, as shown in FIG. 1, the plurality of radiators 2 may form one radiator array 20. Each radiator array 20 may include two columns of radiators, which may be denoted as the first column 201 of radiators and the second column 202 of radiators. For example, as shown in FIG. 1, the six radiators 2a to 2f form one radiator array 20. In the radiator array 20, the first column 201 of radiators includes three radiators 2, which may be respectively denoted as the radiator 2a, the radiator 2b, and the radiator 2c for ease of differentiation; and the second column 202 of radiators includes three radiators 2, which may be respectively denoted as the radiator 2d, the radiator 2e, and the radiator 2f for ease of differentiation. For another example, as shown in FIG. 2, 12 radiators may form two radiator arrays 20, which may be respectively denoted as a radiator array 20a and a radiator array 20b for ease of differentiation. In the radiator array 20a, a first column 201a of radiators includes a radiator 2a, a radiator 2b, and a radiator 2c, and a second column 202a of radiators includes a radiator 2d, a radiator 2e, and a radiator 2f. In the radiator array 20b, a first column 201b of radiators includes a radiator 2g, a radiator 2h, and a radiator 2i, and a second column 202b of radiators includes a radiator 2j, a radiator 2k, and a radiator 2m.

A quantity of radiator arrays 20 included in the antenna apparatus is not limited in this embodiment, and a skilled person can perform flexible selection based on an environment in which the antenna apparatus is located.

In the following, the first column 201 of radiators and the second column 202 of radiators are two column of radiators in a same radiator array 20 unless otherwise specified.

In an example, to enable the antenna apparatus to have a dual polarization feature, correspondingly, the polarization direction of the first column 201 of radiators is perpendicular to the polarization direction of the second column 202 of radiators. For example, the polarization direction of the first column 201 of radiators is +45 degrees, and the polarization direction of the second column 202 of radiators is −45 degrees. Alternatively, the polarization direction of the first column 201 of radiators is −45 degrees, and the polarization direction of the second column 202 of radiators is +45 degrees.

In an example, to avoid mutual interference between the radiators 2 in the first column 201 of radiators and the radiators 2 in the second column 202 of radiators, correspondingly, the radiators 2 in the first column 201 of radiators and the radiators 2 in the second column 202 of radiators do no overlap. The radiators 2 in the first column 201 of radiators and the radiators 2 in the second column 202 of radiators are staggered from each other at physical spatial locations, so as to increase an isolation degree.

On the basis that an isolation degree between two adjacent radiators 2 (one is located in the first column 201 of radiators and the other is located in the second column 202 of radiators) meets a minimum requirement of the isolation degree requirement, the first column 201 of radiators and the second column 202 of radiators may be made as close to each other as possible, so as to reduce a space occupied by the antenna apparatus and meet compactness of the antenna apparatus. Optionally, the end of the first radiator in the first column 201 of radiators points to the target location range of the adjacent second radiator in the second column 202 of radiators. The first radiator is any radiator in the first column 201 of radiators, and the second radiator is a radiator in the second column 202 of radiators.

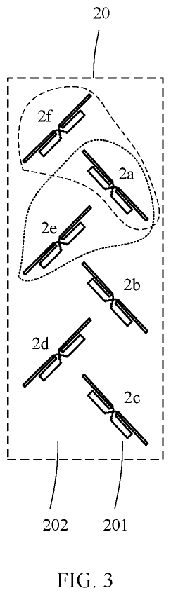

As shown in FIG. 3, the adjacent first radiator and second radiator may be the radiator 2a located in the first column 201 of radiators and the radiator 2f located in the second column 202 of radiators, or may be the radiator 2a located in the first column 201 of radiators and the radiator 2e located in the second column 202 of radiators.

In an example, when an end of the radiator 2a in the first column 201 of radiators points to a target location range of the adjacent radiator 2f in the second column 202 of radiators, and an isolation degree between the radiator 2a and the radiator 2f meets the minimum requirement of the isolation degree requirement, a spacing between the first column 201 of radiators and the second column 202 of radiators is also minimal.

Meeting the isolation degree requirement may be meeting the minimum requirement of the isolation degree requirement. Meeting the minimum requirement of the isolation degree requirement may be being exactly equal to a minimum isolation degree, or being slightly greater than the minimum isolation degree. For example, if the minimum requirement of the isolation degree requirement is 18 decibels (decibel, dB), the isolation degree between the radiator 2a and the radiator 2f may be exactly 18 dB, or may be slightly greater than 18 dB.

A target location range of a radiator (any radiator) may be a location range formed by a middle location on the radiator and an area adjacent to the middle location on the radiator. For example, a target location range of a radiator with a linear-shape appearance may be a location range that is formed by using a straight line at which the radiator is located as a coordinate axis and a middle location on the radiator as a center, and in which the radiator can move leftward for a specified distance and rightward for a specified distance. In this way, an end of each radiator in the first column 201 of radiators may point to a middle location on an adjacent radiator in the second column 202 of radiators, or may point to a specific location close to a middle location on an adjacent radiator in the second column 202 of radiators.

This embodiment sets no absolute limitation on a specific location pointed to by the end of each radiator in the first column 201 of radiators, provided that the minimum requirement of the isolation degree requirement can be met, and the antenna apparatus has highest compactness.

An end of a radiator may point to a target location range of another radiator, or may be pointed to by an end of another radiator.

In an example, as shown in FIG. 1, when the first column 201 of radiators includes the radiator 2a, the radiator 2b, and the radiator 2c, and the second column 202 of radiators includes the radiator 2d, a radiator 2e, and the radiator 2f, each radiator in the first column 201 of radiators is adjacent to one or two radiators in the second column 202 of radiators, and each radiator in the second column 202 of radiators is adjacent to one or two radiators in the first column 201 of radiators. For example, as shown in FIG. 3, for the radiator 2a in the first column 201 of radiators that is adjacent to the radiator 2f and the radiator 2e in the second column 202 of radiators, the end of the radiator 2a points to the target location range of the radiator 2f in the second column 202 of radiators, and a target location range of the radiator 2a is pointed to by an end of the radiator 2e in the second column 202 of radiators. Similarly, for the radiator 2e in the second column 202 of radiators that is adjacent to the radiator 2a and the radiator 2b in the first column 201 of radiators, the end of the radiator 2e points to the target location range of the adjacent radiator 2a in the first column 201 of radiators, and a target location range of the radiator 2e is pointed to by an end of the other adjacent radiator 2b in the first column 201 of radiators.

Based on the foregoing description, all the radiators 2 of the array antenna apparatus are located on one circuit board 1, that is, the radiators 2 share the circuit board. The end of each radiator in the first column 201 of radiators in the radiator array points to a target location range of an adjacent radiator in the second column 202 of radiators. In this way, the first column 201 of radiators and the second column 202 of radiators are as close to each other as possible while a requirement of the isolation degree requirement is met, thereby implementing compactness of the antenna apparatus. Compared with dual polarization implemented by overlapping radiators in a related technology, in the dual-polarized antenna apparatus with the foregoing arrangement, all the radiators are printed on the circuit board. Processing and manufacturing processes are simple, production efficiency is high, manufacturing costs are low, and large-scale production of the antenna apparatus can be implemented.

In an example, as shown in FIG. 1 to FIG. 3, the first column 201 of radiators and the second column 202 of radiators are as close to each other as possible while the antenna apparatus can meet a boundary condition of the isolation degree requirement, so that in each radiator array 20, physical locations of the first column 201 of radiators and the second column 202 of radiators are staggered from each other.

In other words, ends of the radiators 2 in the first column 201 of radiators all extend into an array of the second column 202 of radiators, and ends of the radiators 2 in the second column 202 of radiators all extend into an array of the first column 201 of radiators. For example, still referring to FIG. 3, the ends of the radiator 2a, the radiator 2b, and the radiator 2c located in the first column 201 of radiators all extend into the array of the second column 202 of radiators, and the ends of the radiator 2d, the radiator 2e, and the radiator 2f in the second column 202 of radiators all extend into the array of the first column 201 of radiators.

In this way, the two columns of radiators in each radiator array 20 in the antenna apparatus are staggered from each other. This can improve space utilization of the antenna apparatus and facilitate compactness of the antenna apparatus.

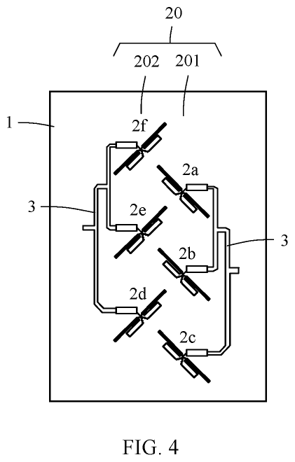

In an example, the antenna apparatus further includes a feeding component 3 configured to feed the radiators 2. To further improve the processing and manufacturing processes of the antenna apparatus, correspondingly, the feeding component 3 of the antenna apparatus may also be printed on the circuit board 1. As shown in FIG. 4, the feeding component 3 is located on the circuit board 1, and the feeding component 3 is electrically connected to each of the plurality of radiators 2.

Compared with making the feeding component 3 perpendicular to the circuit board 1, deploying the feeding component 3 on the circuit board 1 can simplify connections between the feeding component 3 and the radiators 2, and save a large quantity of welding or mounting processes.

The feeding component 3 and the radiators 2 share one circuit board 1, that is, the feeding component 3 and the radiators 2 are laid out on a same circuit board 1 in a printing manner. This can greatly simplify processing and manufacturing of the antenna apparatus, improve production and processing efficiency, reduce a cost, and facilitate large-scale production of the antenna apparatus.

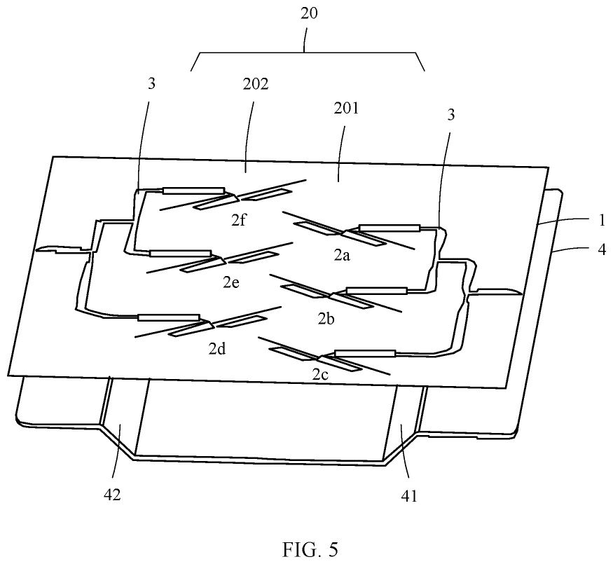

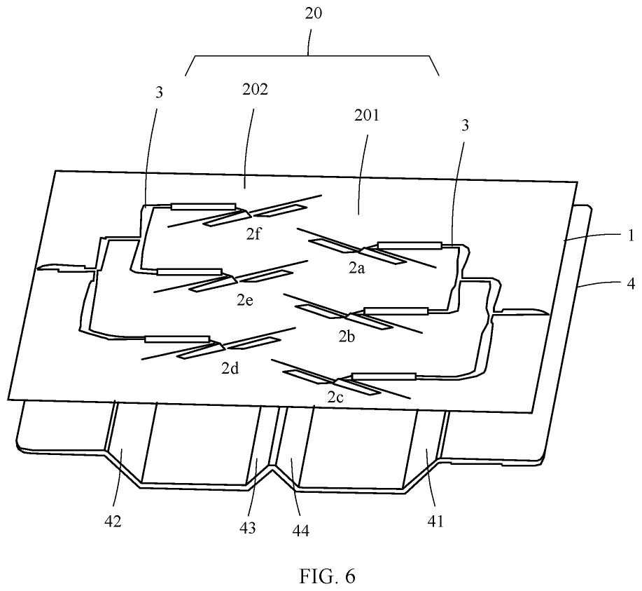

In an example, to implement directionalization of the antenna apparatus, correspondingly, the antenna apparatus further includes a reflection panel 4 (see FIGS. 5-6). The circuit board 1 may be fixedly mounted on the reflection panel 4, the reflection panel 4 and the circuit board 1 may be parallel to each other, and a distance between the reflection panel 4 and the circuit board 1 falls within a specified value range.

The specified value range may be determined based on an index of each parameter in a directivity pattern of the antenna apparatus, for example, may be determined based on symmetry of the directivity pattern, a feature of a main lobe in the directivity pattern, and a feature of a side lobe in the directivity pattern.

A size of the reflection panel 4 may be adaptive to a size on the circuit board 1 that is occupied by the plurality of radiators 2 on the circuit board 1. For example, an area of the reflection panel 4 is adaptive to a total area occupied by all the radiators 2 of the antenna apparatus on the circuit board 1.

In an example, to further optimize the directivity pattern of the antenna apparatus, correspondingly, the reflection panel 4 may have an inclined surface to reflect an electromagnetic wave of the radiators 2.

For example, as shown in FIG. 5, a location that is on the reflection panel 4 and that corresponds to a first boundary of the first column 201 of radiators is bent toward a direction of the circuit board 1 to form a first inclined surface 41. The first boundary of the first column 201 of radiators is a column boundary far from the second column 202 of radiators. The first inclined surface 41 is configured to reflect an electromagnetic wave radiated by the second column 202 of radiators in the radiator array 20 in which the first column 201 of radiators is located. A location that is on the reflection panel 4 and that corresponds to a first boundary of the second column 202 of radiators is bent toward the direction of the circuit board 1 to form a second inclined surface 42. The first boundary of the second column 202 of radiators is a column boundary far from the first column 201 of radiators. The second inclined surface 42 is configured to reflect an electromagnetic wave radiated by the first column 201 of radiators in the radiator array 20 in which the second column 202 of radiators is located.

A column boundary of the first column 201 of radiators is a boundary formed by the ends of the radiators 2 in the first column 201 of radiators, and a column boundary of the second column 202 of radiators is a boundary formed by the ends of the radiators 2 in the second column 202 of radiators.

In an example, the first boundary of the first column 201 of radiators is a boundary formed by ends that are of the radiators 2 in the first column 201 of radiators and that are away from the second column 202 of radiators. A second boundary of the first column 201 of radiators is a boundary formed by ends that are of the radiators 2 in the first column 201 of radiators and that are adjacent to the second column 202 of radiators. Similarly, the first boundary of the second column 202 of radiators is a boundary formed by ends that are of the radiators 2 in the second column 202 of radiators and that are away from the first column 201 of radiators. A second boundary of the second column 202 of radiators is a boundary formed by ends that are of the radiators 2 in the second column 202 of radiators and that are adjacent to the first column 201 of radiators.

For ease of clear description, positional terms “above” and “below” may be introduced. For example, as shown in FIG. 5, a location at which the circuit board 1 is located may be a location “above”, and a location at which the reflection panel 4 is located may be a location “below”.

In an example, the location that is on the reflection panel 4 and that corresponds to the first boundary of the first column 201 of radiators is bent toward the direction of the circuit board 1 to form the first inclined surface 41. In other words, a part that is of the reflection panel 4 and that is located below the first boundary of the first column 201 of radiators is bent toward the direction of the circuit board 1, and rises by a specified height to form the first inclined surface 41.

Similarly, the location that is on the reflection panel 4 and that corresponds to the first boundary of the second column 202 of radiators is bent toward the direction of the circuit board 1 to form the second inclined surface 42. In other words, a part that is of the reflection panel 4 and that is located below the first boundary of the second column 202 of radiators is bent toward the direction of the circuit board 1, and rises by the specified height to form the second inclined surface 42.

In this way, the first inclined surface 41 reflects an electromagnetic wave of the second column 202 of radiators, and the second inclined surface 42 reflects an electromagnetic wave of the first column 201 of radiators.

The specified height depends on an inclination angle of the first inclined surface 41 and the second inclined surface 42 relative to a body part of the reflection panel 4, and the inclination angle of the first inclined surface 41 and the second inclined surface 42 relative to the body part of the reflection panel 14 may be determined by the directivity pattern of the antenna apparatus. For example, the inclination angle of the first inclined surface 41 and the second inclined surface 42 relative to the body part of the reflection panel 4 may be 45 degrees or 60 degrees. This embodiment sets no limitation on the inclination angle of the first inclined surface 41 and the second inclined surface 42 relative to the body part of the reflection panel 4, and a skilled person can flexibly adjust the inclination angle based on an actual situation.

To further optimize the directivity pattern of the antenna apparatus, correspondingly, as shown in FIG. 6, a location that is on the reflection panel 4 and that corresponds to an intersection between the first column 201 of radiators and the second column 202 of radiators in the radiator array 20 protrudes toward the direction of the circuit board 1 to form a third inclined surface 43 and a fourth inclined surface 44. The third inclined surface 43 reflects an electromagnetic wave of the second column 202 of radiators, and the fourth inclined surface 44 reflects an electromagnetic wave of the first column 201 of radiators.

A location of the intersection between the first column 201 of radiators and the second column 202 of radiators is a location at which the first column 201 of radiators and the second column 202 of radiators are close each other, that is, an intersection between the second boundary of the first column 201 of radiators and the second boundary of the second column 202 of radiators.

In an example, a location that is on the reflection panel 4 and that is located directly below the intersection between the first column 201 of radiators and the second column 202 of radiators protrudes toward the direction of the circuit board 1 by a specified distance to form the third inclined surface 43 and the fourth inclined surface 44. As shown in FIG. 6, the third inclined surface 43 faces the second column 202 of radiators to reflect an electromagnetic wave of the second column 202 of radiators, and the fourth inclined surface 44 faces the first column 201 of radiators to reflect an electromagnetic wave of the first column 201 of radiators.

The first inclined surface 41 and the second inclined surface 42 can have a coarse optimization effect on the directivity pattern of the antenna apparatus, and the third inclined surface 43 and the fourth inclined surface 44 can have a fine optimization effect on the directivity pattern of the antenna apparatus.

In this way, the antenna apparatus optimizes the directivity pattern of the antenna apparatus and improves symmetry of the directivity pattern by using reflection functions of the first inclined surface 41, the second inclined surface 42, the third inclined surface 43, and the fourth inclined surface 44 of the reflection panel 4 on electromagnetic waves of the radiators 2, so that a coverage area of the antenna apparatus is uniform and communication quality is improved.

In an example, each of the plurality of radiators 2 may include two symmetrical radiation elements, and the two radiation elements are located on the circuit board 1. For example, one of the two symmetrical radiation elements is located on a first surface of the circuit board 1, and the other radiation element thereof is located on a second surface of the circuit board 1. The first surface and the second surface of the circuit board 1 are surfaces opposite to each other. The radiation element located on the first surface of the circuit board 1 may be denoted as a first radiation element. The radiation element located on the second surface may be denoted as a second radiation element.

In an example, the antenna apparatus may be a single-band antenna, and correspondingly, each radiator 2 may include two symmetrical radiation elements. One of the two symmetrical radiation elements is located on the first surface of the circuit board 1 and the other radiation element thereof is located on the second surface of the circuit board 1.

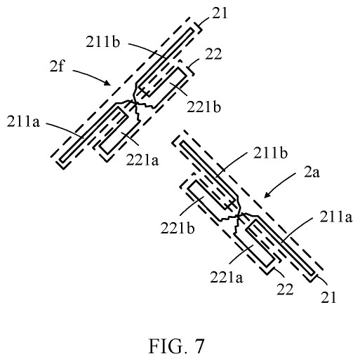

In an example, the antenna apparatus may alternatively be a dual-band antenna. Correspondingly, as shown in FIG. 7, each radiator 2 may include a high-frequency radiating element 21 and a low-frequency radiating element 22. The high-frequency radiating element 21 and the low-frequency radiating element 22 are located on the circuit board 1 in parallel. FIG. 7 shows only the radiator 2a in the first column 201 of radiators and the radiator 2f in the second column 202 of radiators as examples. Other radiators have similar specific structures, and are not described one by one.

An operating band of the high-frequency radiating element 21 may be 5 GHz, and an operating band of the low-frequency radiating element 22 may be 2.4 GHz. The antenna apparatus has two operating bands: 2.4 GHz and 5 GHz.

In an example, similar to the single-band antenna, for the dual-band antenna, the high-frequency radiating element 21 may also include two symmetrical radiation elements 211, and the low-frequency radiating element 22 may also include symmetrical radiation elements 221. For example, as shown in FIG. 7, the radiator 2a in the first column 201 of radiators includes a high-frequency radiating element 21 and a low-frequency radiating element 22. The high-frequency radiating element 21 includes a radiation element 211a and a radiation element 211b. The radiation element 211a is located on the first surface of the circuit board 1, and the radiation element 211b is located on the second surface of the circuit board 1. The low-frequency radiating element 22 includes a radiation element 221a and a radiation element 221b. The radiation element 221a is located on the first surface of the circuit board 1, and the radiation element 221b is located on the second surface of the circuit board 1.

Similarly, the radiator 2f in the second column 202 of radiators includes a high-frequency radiating element 21 and a low-frequency radiating element 22. The high-frequency radiating element 21 includes a radiation element 211a and a radiation element 211b. The radiation element 211a may be located on the first surface of the circuit board 1, and the radiation element 211b may be located on the second surface of the circuit board 1. The low-frequency radiating element 22 includes a radiation element 221a and a radiation element 221b. The radiation element 221a is located on the first surface of the circuit board 1, and the radiation element 221b is located on the second surface of the circuit board 1.

A specific structure of another radiator in the first column 201 of radiators is similar to that of the radiator 2a, and a specific structure of another radiator in the second column 202 of radiator is similar to that of the radiator 2f.

It can be learned that, the antenna apparatus may be a dual-band dual-polarized antenna, and radiators at the two operating bands of the antenna apparatus are located on a same circuit board, so as to implement circuit board sharing and aperture sharing of the antenna apparatus. Aperture sharing means that the high-frequency operating band and the low-frequency operating band of the antenna apparatus share one radiator array. In this way, the high-frequency radiating element and the low-frequency radiating element no longer need to implement aperture sharing through a multiplexer, thereby further simplifying the processing and manufacturing processes.

In an example, the antenna apparatus may further include a protective cover, and both the circuit board 1 and the plurality of radiators 2 are located inside the protective cover. For example, the protective cover may cover the reflection panel 4. The reflection panel 4 may serve as a base of the antenna apparatus. The protective cover covers the reflection panel 4, and serves as an upper cover of the antenna apparatus. The circuit board 1 and the plurality of radiators 2 laid out on the circuit board 1 both are located in a sealed space formed by the reflection panel 4 and the protective cover.

Alternatively, the antenna apparatus may further include a base. The reflection panel 4 is mounted on the base, the circuit board 1 is mounted on the reflection panel 4, the plurality of radiators 2 and the feeding component 3 are printed on the circuit board 1, and the protective cover covers the base. The reflection panel 4, the circuit board 1, and the plurality of radiators 2 and the feeding component 3 that are located on the circuit board 1 are all located in a sealed space formed by the base and the protective cover.

In this application, the antenna apparatus includes the circuit board and the plurality of radiators located on the circuit board. The plurality of radiators may form at least one radiator array, and each radiator array may include the first column of radiators and the second column of radiators. The end of each radiator in the first column of radiators points to a target location range of an adjacent radiator in the second column of radiators, so as to meet a requirement of the isolation degree requirement and compactness of the antenna apparatus. In the dual-polarized antenna apparatus provided with the foregoing arrangement, the first column of radiators and the second column of radiators whose polarization directions are perpendicular to each other are printed on the same circuit board to simplify the processing and manufacturing processes and reduce the manufacturing costs. In addition, the first column of radiators and the second column of radiators whose polarization directions are perpendicular to each other are staggered from each other, so that the antenna apparatus can be more compact while the isolation degree requirement is met.

In addition, the radiators and the feeding component of the antenna apparatus are all printed on the same circuit board. This can simplify the processing and manufacturing processes, reduce a cost, and facilitate large-scale production of the antenna apparatus.

An embodiment of this application further provides a radio communications device. The radio communications device may include a signal device and the foregoing antenna apparatus. The signal device is electrically connected to the feeding component in the antenna apparatus. The signal device may be a signal transmitter, a signal receiver, or a signal transceiver capable of transmitting and receiving signals.

As described above, the antenna apparatus in the radio communications device may include a circuit board and a plurality of radiators located on the circuit board. The plurality of radiators may form at least one radiator array, and each radiator array may include a first column of radiators and a second column of radiators. An end of each radiator in the first column of radiators points to a target location range of an adjacent radiator in the second column of radiators, so as to meet a requirement of an isolation degree requirement and compactness of the antenna apparatus. In the dual-polarized antenna apparatus provided with the foregoing arrangement, the first column of radiators and the second column of radiators whose polarization directions are perpendicular to each other are printed on the same circuit board and share the circuit board to simplify the processing and manufacturing processes and reduce manufacturing costs. In addition, the first column of radiators and the second column of radiators whose polarization directions are perpendicular to each other are staggered from each other, so that the antenna apparatus can be more compact while the isolation degree requirement is met.

The foregoing description is merely an embodiment of this application, but is not intended to limit this application. Any modification, equivalent replacement, or improvement made without departing from the principle of this application shall fall within the protection scope of this application.

What is claimed is:

1. An antenna apparatus, comprising:
a circuit board; and
a plurality of radiators located on the circuit board, the plurality of radiators form at least one radiator array, and each radiator array comprises a first column of radiators and a second column of radiators; and
in each radiator array, a first column polarization direction of the first column of radiators is perpendicular to a second column polarization direction of the second column of radiators, radiators in the first column and radiators in the second column do not overlap; an end of a first radiator in the first column points to a target location range of an adjacent second radiator in the second column of radiators so that an isolation degree between the first radiator and the adjacent second radiator meets an isolation degree requirement, and the first radiator comprising any radiator in the first column of radiators.

2. The antenna apparatus according to claim 1, wherein the target location range of the second radiator is a location range formed by a middle location on the second radiator and an area adjacent to the middle location on the second radiator.

3. The antenna apparatus according to claim 1, wherein the antenna apparatus further comprises a feeding component, the feeding component is located on the circuit board, and the feeding component is electrically connected to each of the plurality of radiators.

4. The antenna apparatus according to claim 1, wherein the antenna apparatus further comprises a reflection panel, the circuit board is mounted on the reflection panel, and a distance between the reflection panel and the circuit board falls within a specified value range.

5. The antenna apparatus according to claim 4, wherein:
a location that is on the reflection panel and that corresponds to a first boundary of the first column of radiators is bent toward a direction of the circuit board to form a first inclined surface, the first boundary of the first column of radiators is a column boundary far from the second column of radiators, and the first inclined surface is configured to reflect an electromagnetic wave radiated by the second column of radiators in the radiator array (in which the first column of radiators is located; and
a location that is on the reflection panel and that corresponds to a first boundary of the second column of radiators is bent toward the direction of the circuit board to form a second inclined surface, the first boundary of the second column of radiators is a column boundary far from the first column of radiators, and the second inclined surface is configured to reflect an electromagnetic wave radiated by the first column of radiators in the radiator array in which the second column of radiators is located.

6. The antenna apparatus according to claim 4, wherein a location that is on the reflection panel and that corresponds to an intersection between the first column of radiators and the second column of radiators in the radiator array protrudes toward the direction of the circuit board to form a third inclined surface and a fourth inclined surface, the third inclined surface is configured to reflect an electromagnetic wave radiated by the second column of radiators, and the fourth inclined surface is configured to reflect an electromagnetic wave radiated by the first column of radiators.

7. The antenna apparatus according to claim 1, wherein a polarization direction of each radiator in the first column of radiators is +45 degrees, and a polarization direction of each radiator in the second column of radiators is −45 degrees.

8. The antenna apparatus according to claim 1, wherein each of the plurality of radiators comprises a high-frequency radiating element and a low-frequency radiating element, and the high-frequency radiating element and the low-frequency radiating element are located on the circuit board in parallel.

9. The antenna apparatus according to claim 1, wherein each of the plurality of radiators comprises two radiation elements that are symmetrical to each other, a first radiation element in the two radiation elements is located on a first surface of the circuit board, a second radiation element in the two radiation elements is located on a second surface of the circuit board, and the first surface is opposite to the second surface.

10. The antenna apparatus according to claim 1, wherein the antenna apparatus further comprises a protective cover, and both the circuit board and the plurality of radiators are located inside the protective cover.

11. A radio communications device, comprising:
a radio device; and
an antenna apparatus, comprising:
a circuit board;
a plurality of radiators located on the circuit board, the plurality of radiators form at least one radiator array, and each radiator array comprises a first column of radiators and a second column of radiators; and
a feeding component formed on the circuit board and coupled to the plurality of radiators;
in each radiator array, a first column polarization direction of the first column of radiators is perpendicular to a second column polarization direction of the second column of radiators, radiators in the first column and radiators in the second column do not overlap; an end of a first radiator in the first column points to a target location range of an adjacent second radiator in the second column of radiators so that an isolation degree between the first radiator and the adjacent second radiator meets an isolation degree requirement, and the first radiator comprising any radiator in the first column of radiators.
